(19) United States
(12) Patent Application Publication
(10) Pub. No.: US 2002/0037413 A1
(43) Pub. Date: Mar. 28, 2002

(54) Pressure-sensitive adhesive compositions and adhesive films

(76) Inventors: Hiroaki Kishioka, Osaka (JP); Jun Harima, Osaka (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/776,806

(22) Filed: Feb. 5, 2001

(30) Foreign Application Priority Data
Feb. 4, 2000 (JP) 2000-26963

(51) Int. Cl. B32B 27/08; B32B 27/30; C08F 8/00; C08L 29/00; C08L 33/02

(52) U.S. Cl. 428/412; 428/483; 428/515; 525/118; 525/119; 525/123; 525/162; 525/163

(57) ABSTRACT

A pressure-sensitive adhesive composition comprising an acrylic polymer as a base polymer and a crosslinking agent, characterized in that said acrylicpolymerh as a weight-average molecular weight of 1,500,000 or above and the proportion of materials having a molecular weight of 100,000 or below in said acrylic polymeris 10% or less, and that the storage modulus at 80° C. of said composition after forming a cross-linked structure is from 5×10⁴ Pa to 5×10⁵ Pa inclusive,which composition is capable of forming an adhesive layer having excellent weather resistance.

### BACKGROUND OF THE INVENTION

1. Field of the Invention

The present invention relates to pressure-sensitive adhesive compositions and adhesive films. An adhesive film of the present invention is useful, for example, as a pressure-sensitive adhesive sheet or pressure-sensitive adhesive tape to be stuck on a transparent plastic. In particular, an adhesive film of the present invention is useful as an adhesive film of which base film is one of various functional films such as conductive film, antiglare film, heat ray shielding film, and antireflective film. The present invention further relates to a display device in which a functional film is stuck on the display area of the display device such as a liquid crystal display device, plasma display, or cathode-ray tube by using the above pressure-sensitive adhesive composition as a fixing and adhering material.

2. Description of the Background Art

Many various applications of adhesives have been developed in recent years in which various films, especially functional films, are stuck and fixed on transparent plastic substrates such as polycarbonates or acrylic resins by using adhesives. For such applications, adhesives are required as a matter of course to have transparency not to spoil the visibility and also required to retain resistance to foaming and peeling even under conditions of high humidity or of high temperature and high humidity so that foaming and peeling do not occur at the adhesive interface (hereinafter referred to as weather resistance).

Under conditions of high humidity or of high temperature and high humidity, however, transparent substrates such as acrylic resins or polycarbonate release gases (attributable to residual monomers or moisture absorbed by the substrate) that may cause foaming. Therefore, in materials in which base films having a certain degree of barrier properties such as polyethylene terephthalate have been laminated onto the above transparent substrate through an adhesive layer, foaming, lifting, and peeling occur at the adhesive interface and seriously spoil the visibility.

Acrylic pressure-sensitive adhesives conventionally used for such applications have been subjected to attempts to improve weather resistance by using, as a base polymer, an acrylic polymer having a molecular weight adjusted to an appropriate range (Japanese Patent Publication Kokai H1-178567 (1989)), an acrylic polymer copolymerized with a monomer that increases adherence, or an acrylic polymer containing an additive such as a tackifier to increase adherence to transparent substrates.

It was not possible, however, to meet high-level requirements because there is a limit to improvement in weather resistance by adjusting the molecular weight of acrylicpolymer to an appropriate range or by adjusting the monomer composition so as to increase the adherence. Likewise, since a high number of parts of a tackifier added to an adhesive spoils the transparency, the amount of a tackifier added is naturally restricted and improvement in weather resistance is thereby limited.

### SUMMARY OF THE INVENTION

Under such circumstances, the present invention aims to provide a pressure-sensitive adhesive composition comprising an acrylic polymer as a base polymer, which composition is capable of forming an adhesive layer having excellent weather resistance on a base film.

The present inventors have concentrated their efforts on solving the above-described problems, and found that there is a correlation between the molecular weight and the molecular weight distribution of an acrylic polymer constituting a pressure-sensitive adhesive composition and the weather resistance, and further that the storage modulus of the adhesive layer a pressure-sensitive adhesive composition forms closely correlates with the weather resistance. The present inventors then found out that by adjusting these factors to certain ranges as described below, the above-described object may be achieved, and thus completed the present invention.

More specifically, the present invention relates to a pressure-sensitive adhesive composition comprising an acrylic polymer and a crosslinking agent, characterized in that said acrylicpolymerh as a weight-average molecular weight of 1,500,000 or above and the proportion of materials having a molecular weight of 100,000 or below in said acrylic polymer is 10% or less, and that the storage modulus at 80° C. of said composition after forming a cross-linked structure is from 5×10⁴ Pa to 5×10⁵ Pa inclusive.

In this connection, the weight-average molecular weight and the molecular weight distribution of an acrylic polymer described above are determined as standard polystyrene equivalent by a gel permeation chromatographic method (hereinafter referred to as GPC method) with 0.1% solution of an acrylic polymer in tetrahydrofuran using an eluent (tetrahydrofuran). The column temperature and the flow rate were set to 40° C. and 1.0 ml/min, respectively.

The storage modulus (G′) described above is determined as follows: a test sample prepared by overlaying a pressure-sensitive adhesive composition so that the thickness of the cross-linked structure will be about 1.5 mm was mounted on parallel plates (7.9 mm diameter), and the storage modulus was measured at a speed of 6.28 rad/s in Advanced Rheometric Expansion System (ARES) (Rheometric Scientific, Inc.). The measurement was conducted in the range of −70° C. to 200° C. at a heating rate of 5° C./min.

As described above, an acrylic polymer used in a composition of the present invention is such that it has a high weight-average molecular weight and the proportion of low molecular weight materials having a molecular weight of 100,000 or below in the polymer is low. Since weather resistance of an acrylic polymer improves as the weight-average molecular weight of the polymer increases and as the proportion of the low molecular weight materials in the polymer decreases, the weight-average molecular weight of the acrylic polymer is preferably 2,000,000 or above, and the proportion of the low molecular weight materials is more preferably 5% or less. Although there is no particular upper limit to the weight-average molecular weight, those polymers having a weight-average molecular weight up to 7,000,000 are usually used.

Furthermore, a composition of the present invention comprises the above-described acrylic polymer and a crosslinking agent and is specified by the storage modulus value at 80° C. of the composition after forming a cross-linked structure. Specifically, at the above-described storage modulus values, the cross-linked structures have satisfactory adhesive properties and also exhibit improved weather resistance. The storage modulus value is preferably 1×10⁵ Pa or above and also preferably not more than 3×10⁵ Pa, since in such range, the composition exhibits excellent adhesive properties.

Thus, a pressure-sensitive adhesive composition of the present invention is specified by the physical properties concerning average molecular weight and molecular weight distribution of the acrylic polymer and by the physical a properties of the composition after forming a cross-linked structure, and the present invention achieves excellent adhesive properties and weather resistance of the adhesive composition by specifying such physical properties. In addition, a pressure-sensitive composition of the present invention has excellent transparency as well as excellent thermal resistance.

The present invention further relates to an adhesive film in which a cross-linked structure layer of the above-described pressure-sensitive adhesive composition is provided on a base film.

The adhesive film is prepared by coating and curing an above-described pressure-sensitive adhesive composition on a base film. The base films may be selected as appropriate according to the intendeduse of the adhesive film. The adhesive composition is particularly useful when it is applied on a functional film requiring weather resistance.

In a preferred adhesive film, the 180° tensile adhesive strength of the cross-linked structure layer provided on a base film to acrylic resins (e.g. polymethyl methacrylate), polycarbonates, and polyesters (e.g. polyethylene terephthalate) is 10 N or above per 20 mm. Thus, an adhesive film of the present invention exerts satisfactory adhesive strength to various transparent plastics.

Furthermore, the present invention relates to a display device in which a functional film is stuck on the surface of the display area of the display device by means of a cross-linked structure of a pressure-sensitive adhesive composition described above. A display device in which a functional film is stuck on the surface of the display area by means of a pressure-sensitive adhesive composition of the present invention has excellent weather resistance.

### DESCRIPTION OF THE PREFERRED EMBODIMENTS

An acrylic polymer used as a base polymer in a pressure-sensitive adhesive composition of the present invention is a homopolymer or copolymer of a monomer or monomers comprising alkyl (meth)acrylate as a principal component.

As used herein, “alkyl (meth)acrylate” means alkyl acrylate and/or alkyl methacrylate (hereinafter the term “(meth)” has the same similar meaning anywhere it occurs). The alkyl group may be straight or branched, and has usually about 1 to 18 carbon atoms. Specific examples of alkyl (meth)acrylates include, but not limited to, methyl (meth) acrylate, ethyl (meth) acrylate, propyl (meth) acrylate, butyl (meth)acrylate, 2-ethylhexyl (meth)acrylate, octyl (meth)acrylate, nonyl (meth)acrylate, and lauryl (meth)acrylate.

In addition to, and in combination with, the above-described alkyl (meth)acrylate(s), other monomers copolymerizable therewith may also be used in the acrylic polymers. As such other copolymerizable monomers, various monomers known as monomers for modifying acrylic polymers used in acrylic pressure-sensitive adhesives may be used, including vinyl acetate, styrene, (meth)acrylonitrile, (meth)acrylamide, (meth)acrylic acid, 2-hydroxyethyl (meth)acrylate, 3-hydroxypropyl (meth)acrylate, 4-hydroxybutyl (meth)acrylate, 6-hydroxyhexyl (meth)acrylate, glycidyl (meth)acrylate, methoxyethyl (meth) acrylate, and N,N-dimethylaminoethyl (meth) acrylate. Such other copolymerizable monomers are usually used in the proportion of 50% by weight or less based on the total amount of the monomers constituting the acrylic polymer.

For adjusting the storage modulus to the above-described range, an optional monomer used is preferably a monomer reactive with the crosslinking agent. For example, when an isocyanate compound is used as the crosslinking agent, it is preferred to use a hydroxyalkyl (meth)acrylate containing a hydroxyl group, preferably in an amount of about 0.01 to 5% by weight, and more preferably of 0.01 to 1% by weight, based on the total amount of the monomers constituting the acrylic polymer.

For preparing an acrylic polymer of the present invention, various methods maybe adopted without particular restrictions. For example, according to the usual method, a monomer or monomers comprising as a principal component an alkyl (meth) acrylate described above may be polymerized, for example, by solution polymerization, emulsion polymerization or bulk polymerization using a polymerization initiator such as an azo compound or a peroxide, by photopolymerization using a photoinitiator, or by a polymerization method involving irradiation, and an organic solvent which can dissolve only the low molecular weight component may be then added to the resulting polymer in order to fractionally remove only a low molecular weight component. Other methods for preparing acrylic polymers of the present invention include, but not limited to, a method in which a solvent having a small chain transfer constant is used as a polymerization solvent in solution polymerization, a method in which polymerization is conducted with a high monomer concentration at as low temperature as possible, and a photopolymerization using a photoinitiator in which process conditions during polymerization are appropriately selected. In preparation of acrylic polymers, any selected polymerization process as described above may also be combined as appropriate with the above process for removing the low molecular weight component after polymerization.

In a pressure-sensitive adhesive composition of the present invention, any crosslinking agent conventionally known may be used without particular restrictions; it is particularly preferred to use a polyfunctional isocyanate compound. Examples of polyfunctional isocyanate compounds include, for example, tolylene diisocyanate, hexamethylene diisocyanate, polymethylene polyphenyl diisocyanate, diphenylmethane diisocyanate, trimethylolpropane tolylene diisocyanate, polyether polyisocyanate, and polyester polyisocyanate. These is isocyanate compounds are suitably used in an amount of about 0.01 to 20 parts by weight, and preferably in an amount in the range of 0.05 to 15 parts by weight, per 100 parts by weight of the above acrylic polymer.

Other crosslinking agents,which may be preferably used, are polyfunctional melamine compounds and polyfunctional epoxy compounds. Specific examples of polyfunctional melamine compounds are methylated methylol melamine and butylated hexamethylol melamine, and specific examples of polyfunctional epoxy compounds are diglycidyl aniline and glycerin diglycidyl ether. These crosslinking agents are suitably used in an amount of about 0.001 to 10 parts by weight, and preferably in an amount in the range of 0.001 to 5 parts by weight, per 100 parts by weight of the acrylic polymer.

In addition to the acrylic polymer and the crosslinking agent described above, a pressure-sensitive adhesive composition of the present invention may also comprise solvents or various additives such as tackifier, plasticizer, filler, coloring agent, or UV absorber, to the extent that they are not adverse to the purpose of the present invention.

An adhesive film of the present invention is a film in which the above pressure-sensitive adhesive composition is provided as a cross-linked structure layer on a base film. The cross-linked structure layer is formed by coating and drying (curing) a pressure-sensitive adhesive composition on a base film.

The adhesive film may be in the form in which the cross-linked structure layer (pressure-sensitive adhesive layer) is provided on a single side or both sides of the base film, as in so-called pressure-sensitive adhesive sheets (self-adhesive sheets) or pressure-sensitive adhesive tapes (self-adhesive tapes). Alternatively, the adhesive film may also be in the form to be used without base materials wherein the cross-linked structure layer is provided on a release liner (base film) of which surface has been release-treated (mold release-treated) to form a configuration similar to that described above.

Any base film conventionally used may be employed without particular restrictions. For example, various plastic films such as polyethylene terephthalate film, polycarbonate film, and triacetylcellulose film may be used. The thickness of the base film is usually about 10 to 1000 μm. When the base film is one of various functional films such as conductive film, antiglare film, heat ray shielding film, and antireflective film, the thickness of such functional film is usually preferred to be about 50 to 200 μm.

The thickness of the cross-linked structure layer of pressure-sensitive adhesive composition formed on the adhesive film is usually about 5 to 500 μm, and preferably about 10 to 100 μm. Drying (curing) of pressure-sensitive adhesive composition is usually conducted at about 80 to 150° C. for about 2 to 5 minutes.

Furthermore, a display device of the present invention is produced by sticking a functional film in the form of an adhesive film of the present invention on the display area of the display device.

### EXAMPLES

The present invention is specifically described below with reference to the following examples, but the present invention is not so restricted to such examples. In the following examples, the number of parts and percents are all on a weight basis.

Preparation 1 (Preparation of acrylic polymer)

(1) Synthesis of Acrylic Polymer

In a three-necked flask, 60 parts of ethyl acrylate, 35 parts of butyl acrylate, 5 parts of acrylic acid, 0.06 parts of 3-hydroxypropyl acrylate, and 45 parts of ethyl acetate as a polymerization solvent were placed, and stirred for 2 hours while introducing nitrogen gas. After removing oxygen in the polymerization system in this way, 0.2 parts of benzoyl peroxide was added. The temperature was raised to 70° C. and the reaction was allowed to proceed for 10 hours. Then, ethyl acetate was added to the reaction liquid to yield an acrylic polymer solution (A-1) having a solid content of 30%. The weight-average molecular weight of the obtained acrylic polymer (A-1) was 2,000,000, and the proportion of materials having a molecular weight of 100,000 or below in the polymer was 14%.

(2) Adjustment of Molecular Weight and Other Properties

To

100 parts of the acrylic polymer solution (A-1), 120 parts of n-heptane was added dropwise with stirring over 6 hours. The mixture was allowed to stand for 24 hours and the supernatant was then removed. Next, to the polymer solution from which the supernatant had been removed, toluene was added to dissolve the polymer, and a treatment in which 120 parts of n-heptane was added and the supernatant was removed as described above was further repeated five times. To the final polymer solution thus obtained, 80 parts of toluene was added and the mixture was concentrated to yield an acrylic polymer solution (A-2) having apolymer concentration of 25% by weight. The weight-average molecular weight of the obtained acrylic polymer (A-2) was 2,600,000, and the proportion of materials having a molecular weight of 100,000 or below in the polymer was 5%.

Preparation 2 (Preparation of Acrylic Polymer)

An acrylic polymer solution (B-1) was obtained using the same polymerization method as in Preparation 1 (1) with the exception that the kinds and amounts of the monomers used were 45 parts of methyl acrylate, 52 parts of 2-ethylhexyl acrylate, 3 parts of acrylic acid, and 0.06 parts of 3-hydroxypropyl acrylate. The weight-average molecular weight of the obtained acrylic polymer (B-1) was 1,900,000, and the proportion of materials having a molecular weight of 100,000 or below in the polymer was 12%.

The acrylic polymer solution (B-1) was then subjected to the same treatment as in Preparation 1 (2) to yield an acrylic polymer solution (B-2). The weight-average molecular weight of the acrylic polymer (B-2) was 3,200,000, and the proportion of materials having a molecular weight of 100,000 or below in the polymer was 4%.

Preparation 3 (Preparation of Acrylic Polymer)

An acrylic polymer solution (C-1) was obtained using the same polymerization method as in Preparation 1 (1) with the exception that the kinds and amounts of the monomers used were 70 parts of methyl acrylate, 10 parts of butyl acrylate, 10 parts of acrylic acid, 10 parts of acrylonitrile, and 0.06 parts of 3-hydroxypropyl acrylate. The weight-average molecular weight of the obtained acrylic polymer (C-1) was 2,000,000, and the proportion of materials having a molecular weight of 100,000 or below in the polymer was 12%.

The acrylic polymer solution (C-1) was then subjected to the same treatment as in Preparation 1 (2) to yield an acrylic polymer solution (C-2). The weight-average molecular weight of the acrylic polymer (C-2) was 3,900,000, and the proportion of materials having a molecular weight of 100,000 or below in the polymer was 4%.

Preparation 4 (Preparation of Acrylic Polymer)

An acrylic polymer solution (D-1) was obtained using the same polymerization method as in Preparation 1 (1) with the exception that the kinds and amounts of the monomers used were 70 parts of 2-ethylhexyl acrylate, 20 parts of isobutyl acrylate, 3 parts of acrylic acid, 10 parts of methoxyethyl acrylate, and 0.05 parts of 3-hydroxypropyl acrylate. The weight-average molecular weight of the obtained acrylic polymer (D-1) was 1,500,000, and the proportion of materials having a molecular weight of 100,000 or below in the polymer was 17%.

The acrylic polymer solution (D-1) was then subjected to the same treatment as in Preparation 1 (2) to yield an acrylic polymer solution (D-2). The weight-average molecular weight of the acrylic polymer (D-2) was 2,200,000, and the proportion of materials having a molecular weight of 100,000 or below in the polymer was 4%.

Preparation 5 (Preparation of Acrylic Polymer)

(1) Synthesis of Acrylic Polymer

In a three-necked flask, 60 parts of ethyl acrylate, 35 parts of butyl acrylate, 5 parts of acrylic acid, 0.06 parts of 3-hydroxypropyl acrylate, and 100 parts of ethyl acetate as a polymerization solvent were placed, and stirred for 2 hours while introducing nitrogen gas. After removing oxygen in the polymerization system in this way, 0.2 parts of benzoyl peroxide was added. The temperature was raised to 75° C. and the reaction was allowed to proceed for 7 hours. Then, ethyl acetate was added to the reaction liquid to yield an acrylic polymer solution (E-1) having a solid content of 30% by weight. The weight-average molecular weight of the acrylic polymer (E-1) was 900,000, and the proportion of materials having a molecular weight of 100,000 or below in the polymer was 15%. (2) Adjustment of molecular weight and other properties

To 100 parts of the acrylic polymer solution (E-1), 120 parts of n-heptane was added dropwise with stirring over 6 hours. The mixture was allowed to stand for 24 hours and the supernatant was then removed. Next, to the polymer solution from which the supernatant had been removed, toluene was added to dissolve the polymer, and the treatment in which 120 parts of n-heptane was added and the supernatant was removed as described above was further repeated five times. To the final polymer solution thus obtained, 80 parts of toluene was added and the mixture was concentrated to yield an acrylic polymer solution (E-2) having apolymer concentration of 25% by weight. The weight-average molecular weight of the obtained acrylic polymer (E-2) was 1,200,000, and the proportion of materials having a molecular weight of 100,000 or below in the polymer was 5%.

### Example 1

To 100 parts of acrylic polymer solution (A-2) , 1.5 parts of tolylene duisocyanate was added to prepare a pressure-sensitive adhesive composition (solution). This solution was applied by cast coating on a 50-aim-thick polyethylene terephthalate film of which surface had been mold release-treated (release liner) so that the thickness after drying would be about 25 aim, heat-dried at 130IC for 3 minutes, and further aged at 50° C. for 72 hours to make a pressure-sensitive adhesive sheet that comprised a pressure-sensitive adhesive layer having cross-linked structure.

### Example 2

A pressure-sensitive adhesive sheet was obtained in the same manner as in Example 1 with the exceptions that the acrylic polymer solution (B-2) was used in place of the acrylic polymer solution (A-2) in Example 1 and that 1.0 part of diphenylmethane diisocyanate was used in place of 1.5 parts of tolylene diisocyanate in Example 1.

### Comparative Example 1

A pressure-sensitive adhesive sheet was obtained in the same manner as in Example 1 with the exceptions that the acrylic polymer solution (C-2) was used in place of the acrylic polymer solution (A-2) in Example 1 and that 0.8 parts of trimethylolpropane tolylene duisocyanate was used in place of 1.5 parts of tolylene dulsocyanate in Example 1.

### Comparative Example 2

A pressure-sensitive adhesive sheet was obtained in the same manner as in Example 1 with the exceptions that the acrylic polymer solution (D-2) was used in place of the acrylic polymer solution (A-2) in Example 1 and that 0.01 parts of glycerine diglycidyl ether was used in place of 1.5 parts of tolylene diisocyanate in Example 1.

### Comparative Example 3

A pressure-sensitive adhesive sheet was obtained in the same manner as in Example 1 with the exceptions that the acrylic polymer solution (E-2) was used in place of the acrylic polymer solution (A-2) in Example 1 and that 0.015 parts of glycerine diglycidyl ether was used in place of 1.5 parts of tolylene diisocyanate in Example 1.

### Comparative Example 4

A pressure-sensitive adhesive sheet was obtained in the same manner as in Example 1 with the exceptions that the acrylic polymer solution (A-1) was used in place of the acrylic polymer solution (A-2) in Example 1 and that 0.6 parts of trimethylolpropane tolylene diisocyanate was used in place of 1.5 parts of tolylene diisocyanate in Example 1.

The pressure-sensitive adhesive sheets obtained in the above Examples and Comparative Examples were measured for their storage modulus, and their adhesive strength and weather resistance were also evaluated in the following tests. The evaluation results are shown in Table 1. For reference, the weight-average molecular weight of polymer used and the proportions of materials having molecular weight of 100,000 or below in the polymer determined by GPC method are also included in Table 1.

Adhesive Strength Test

Each pressure-sensitive adhesive sheet was laminated onto a polycarbonate sheet (100 μm thick), and test pieces 20 mm in width and 120 mm in length were then prepared. After removing the release liner, the test pieces were each stuck on a polyethylene terephthalate sheet, an acrylic resin plate (polymethyl methacrylate), or a polycarbonate sheet, and bonded together using a roller having a weight of 19.6 N reciprocating once on a glass plate under atmosphere at 23° C. After leaving at 50° C. for one day and standing to cool to 23° C., the peel adhesive strength was measured using a TENSILON-type tester at a peeling rate of 300 mm/min.

Weather Resistance Test

Each pressure-sensitive adhesive sheet was laminated onto a polyethylene terephthalate film (188 Am thick), and after removing the release liner, stuck and fixed on an acrylic resin plate (2 mm thick) to prepare test pieces. These test pieces were then placed under the conditions at 80° C. or 60° C. and 95% R. H. for 500 hours to conduct a weather resistance test. After completion of this weather resistance test, the test pieces were evaluated by visual inspection, wherein test pieces showing no appearance defect such as bubble or lifting at the adhesive interface were recorded with “O”, and any test pieces showing any such bubble or lifting were recorded with “X” regardless of the extent of the defects.

TABLE 1

| | Example | Example | Comparative | Comparative | Comparative | Comparative |
|---|---|---|---|---|---|---|
| | 1 | 2 | Example 1 | Example 2 | Example 3 | Example 4 |
| Acrylic polymer | A-2 | B-2 | C-2 | D-2 | E-2 | A-1 |
| used | | | | | | |
| Weight—average | 260 | 320 | 390 | 220 | 120 | 200 |
| molecular weight | | | | | | |
| (×10⁴) | | | | | | |
| Proportion of | 5 | 4 | 4 | 4 | 5 | 14 |
| materials having | | | | | | |
| molecular weight | | | | | | |
| of 100,000 or below | | | | | | |
| (%) | | | | | | |
| Storage modulus | 1 | 3.5 | 5.5 | 0.3 | 0.8 | 1 |
| (×10⁵ Pa) | | | | | | |
| Adhesive strength | | | | | | |
| (N/20 mm) | | | | | | |
| to PET | 14 | 12 | 10 | 12 | 13 | 13 |
| to Acrylic resin | 18 | 14 | 11 | 13 | 16 | 17 |
| to PC | 19 | 14.5 | 11 | 15 | 16 | 18 |
| Weather | ◯ | ◯ | X | X | X | X |
| resistance | | | | | | |

What is claimed is:

1. A pressure-sensitive adhesive composition comprising an acrylic polymer and a crosslinking agent, characterized in that said acrylic polymer has a weight-average molecular weight of 1,500,000 or above and the proportion of materials having a molecular weight of 100,000 or below in said acrylic polymer is 10% or less, and that the storage modulus at 80° C. of said composition after forming a cross-linked structure is from 5×10⁴ Pa to 5×10⁵ Pa inclusive.

2. An adhesive film in which a cross-linked structure layer of a pressure-sensitive adhesive composition according to claim 1 is provided on a base film.

3. The adhesive film according to claim 2, wherein the base film is a functional film.

4. The adhesive film according to claim 2 or 3, wherein 180° tensile adhesive strength of the cross-linked structure layer of the pressure-sensitive adhesive composition to acrylic resins, polycarbonates, and polyesters is 10 N or above per 20 mm.

5. A display device in which a functional film is stuck on the surface of the display area of the display device by means of a cross-linked structure of a pressure-sensitive adhesive composition according to claim 1.
